(19) United States
(12) Patent Application Publication
(10) Pub. No.: US 2009/0255873 A1
(43) Pub. Date: Oct. 15, 2009

(54) LOW PRESSURE BACKWASH

(76) Inventors: Bruce Gregory Biltoft, New South Wales (AU); Zhiyi Cao, New South Wales (AU); Huw Alexander Lazaredes, New South Wales (AU); Fufang Zha, New South Wales (AU); Lyvonne Ly, New South Wales (AU)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/439,209

(22) PCT Filed: Aug. 30, 2007
(86) PCT No.: PCT/AU2007/001252

§ 371 Date: Feb. 27, 2009

(30) Foreign Application Priority Data
Aug. 31, 2006 (AU) 2006904763

(51) Int. Cl. B01D 65/02; B01D 61/00

(52) U.S. Cl. 210/636; 210/151

(57) ABSTRACT

A method of backwashing a membrane filtration system comprising at least one permeable hollow membrane, the method comprising the step of applying a low-pressure gas to the permeate remaining present in the system when the filtration process is stopped or suspended to provide liquid for backwashing the pores of the membrane during a backwashing process.

### TECHNICAL FIELD

The present invention relates to membrane filtration systems and more particularly to methods and systems for backwashing such systems.

### BACKGROUND OF THE INVENTION

Backwashing of membrane filtration systems is important part of maintaining the operating efficiency of such systems. A variety of different methods and arrangements are used. Porous membrane filtration systems require regular backwashing of the membranes to maintain filtration efficiency and flux while reducing transmembrane pressure (TMP) which rises as the membrane becomes fouled with impurities. Typically, during the backwash cycle, the foulant is removed from the membrane by pressurised gas, liquid or both into the feed tank or cell. The liquid containing impurities and deposits from the membranes is then drained or flushed from the tank. Further cleaning of the membranes may be provided by scouring the surface of the membranes with gas bubbles.

Many of these systems require complex and expensive ancillary equipment to provide the necessary flow to liquid and/or gas to achieve efficient cleaning. In areas which require low capital and operating costs it is desirable to reduce the complexity and expense of ancillary backwash equipment.

### DISCLOSURE OF THE INVENTION

It is an object of the present invention to overcome or ameliorate at least one of the disadvantages of the prior art, or to provide a useful alternative.

According to one aspect the present invention provides an improved method of backwashing a membrane filtration system comprising at least one permeable hollow membrane, the method comprising the step of applying a low-pressure gas to the permeate remaining present in the system when the filtration process is stopped or suspended to provide liquid for backwashing the pores of the membrane during a backwashing process.

According to another aspect the present invention provides a method of filtering solids from a liquid suspension comprising:

(i) providing a pressure differential across the walls of permeable, hollow membranes immersed in the liquid suspension, said liquid suspension being applied to the outer surface of the porous hollow membranes to induce and sustain filtration through the membrane walls wherein:

(a) some of the liquid suspension passes through the walls of the membranes to be drawn off as permeate from the hollow membrane lumens, and

(b) at least some of the solids are retained on or in the hollow membranes or otherwise as suspended solids within the liquid surrounding the membranes,

(ii) periodically backwashing the membrane pores using the permeate remaining within the lumens by applying low pressure gas at a pressure below the bubble point of the membrane to said liquid permeate to displace at least some of the liquid permeate within the lumens through the membrane pores resulting in removal of the solids retained on or in the hollow membranes.

According to another aspect, the present invention provides a method of filtering solids from a liquid suspension in a filtration system comprising:

(i) providing a pressure differential across the walls of permeable, hollow membranes having a liquid suspension applied to the inner surface of the permeable hollow membranes to induce and sustain filtration through the membrane walls wherein:

(a) some of the liquid suspension passes through the walls of the membranes to be drawn off as permeate from the outer surface of said membranes, and

(b) at least some of the solids are retained on or in the hollow membranes or otherwise as suspended solids within the membranes,

(ii) stopping or suspending the filtration process;

(iii) periodically backwashing the membrane pores using the permeate remaining in the system after the suspension of the filtration process by applying a low pressure gas at a pressure below the bubble point of the membrane to said liquid permeate to displace at least some of the liquid permeate through the membrane pores resulting in removal of the solids retained on or in the hollow membranes.

Preferably, during the backwashing step the solids are removed into the bulk liquid surrounding the membranes.

Preferably, permeate remaining in ancillaries such as manifolds, headers, piping and the like may also be used in addition to that in the membrane lumens as a source of backwash liquid. Where insufficient permeate volume for backwash is available from these sources, a further chamber or reservoir may be provided in the permeate flow circuit to increase the amount of permeate available for backwashing when filtration is suspended.

Where a number of the membrane modules are used in a bank and connected to a manifold for distributing feed and removing permeate, the low pressure gas may be introduced into the manifold of the bank of modules so that the permeate in the manifold can also be utilized for backwash. In the case of a filtration process where permeate is taken from both ends of the membrane module, the gas pushed backwash can be selected to apply to the either end only of the membrane modules, or to both ends at the same time, depending on the requirement.

According to another aspect the present invention provides a filtration system for removing fine solids from a liquid suspension comprising:

(i) a vessel for containing said liquid suspension;

(ii) a plurality of permeable, hollow membranes within the vessel;

(iii) means for providing a pressure differential across walls of said membranes such that some of the liquid suspension passes through the walls of the membranes to be drawn off as permeate;

(iv) means for withdrawing permeate from the membranes; and

(v) means for applying low pressure gas at a pressure below the bubble point of the membrane to the liquid permeate within the system and the membrane lumens to cause a discharge of at least some of the liquid permeate in the lumens through the membrane walls to dislodge any solids retained therein and displace the removed solids into the liquid suspension surrounding the membranes.

For preference, the low-pressure gas is provided by one or more gas pressure pulses. Preferably, the low-pressure gas is provided from a source of gas used to aerate the membranes, for example, a low-pressure blower. For preference, the gas pressure may be regulated by a control valve or pressure-limiting device.

Preferably, the low-pressure gas is employed to push the remaining permeate through the membrane pores during backwashing of the membranes.

Preferably, the pressure of the gas applied to the permeate should be less than the bubble point of the membrane so that the gas cannot penetrate into membrane pores.

Preferably the low-pressure gas is the pressure range of about 30 kPa to about 150 kPa. More preferably, the low pressure is available from the same blower used for air scouring of the membrane.

For preference, the pressure pulse or pulses are provided by isolating the feed side of the membranes during the backwash step while applying low pressure gas to both the feed and permeate sides of the membranes to pressurize the feed and permeate sides of the membranes, then opening the feed side of the membranes to atmosphere resulting in a depressurisation of the feed side and the application of a pulse of pressure to the permeate side of the membranes.

A general backwash procedure using the improved method may involve a number or all of the following steps.

Filtering-down of feed level within the feed vessel using aeration gas or other low-pressure gas sources;

Scouring of membrane surfaces by flowing gas bubbles past the membrane surfaces;

Backwashing the membrane pores by flowing permeate remaining present in the system in a reverse direction to the normal filtration flow through the membrane pores by applying a low pressure gas continuously or in a pulsed fashion to the permeate;

Discharging of backwash waste by sweep, drain-down or by a feed and bleed process to partially discharge backwash waste;

Refilling the membrane vessel, venting gas on the permeate side and resuming filtration.

### BRIEF DESCRIPTION OF THE DRAWINGS

Preferred embodiments of the invention will now be described, by way of example only, with reference to the accompanying drawings in which:

FIG. 1 shows a simplified schematic of a membrane module arrangement according to one embodiment of the present invention;

FIG. 2 shows a graphical comparison of low-pressure backwash to a standard high-pressure backwash by comparing the membrane resistance changes over time;

FIG. 3 shows a snapshot of the multiple backwash pulses; and

FIG. 4 shows a graphical comparison of multiple pulsed low pressure backwash to a low pressure backwash by comparing the membrane resistance changes over time.

### DESCRIPTION OF PREFERRED EMBODIMENTS

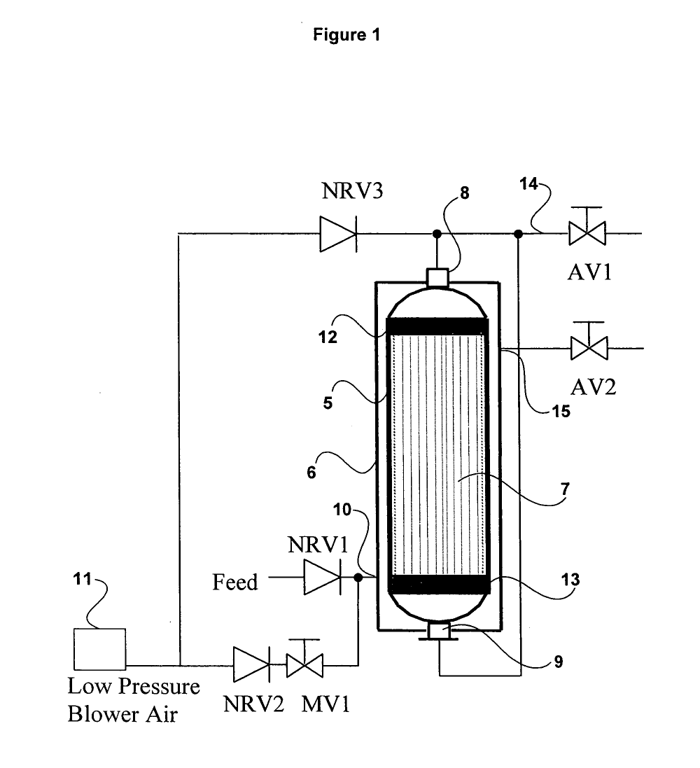

Referring to FIG. 1, the hollow fibre membrane module 5 is mounted in a pressure vessel 6 and the filtration flow is from the shell side into the fibre lumens 7. The module 5 is connected to upper and lower permeate outlets 8 and 9, respectively. When the filtration process is suspended for a cleaning cycle, the lumens 7 remain filled with permeate.

Feed is supplied to the vessel 6 through an inlet port 10 adjacent the lower end of the module 5 through a non-return valve NRV1. Low-pressure blower gas, typically air, is supplied to the inlet port 10 through a non-return valve NRV2 and manually operated control valve MV1. Low-pressure blower air is also fed from a blower 11 to the upper permeate outlet 8 through non-return valve NRV3. Permeate is withdrawn from the membrane lumens through the upper and lower headers 12 and 13 and respective upper and lower module permeate outlets 8 and 9. The withdrawn permeate flows through a permeate line 14 controlled by valve AV1. The pressure vessel 6 is provided with an exhaust port 15 towards the upper end of the module 5 and controlled by a backwash release valve AV2.

Two methods of low-pressure backwash may be used in this embodiment.

In one method, a manual valve MV1 is used to create a differential pressure across the membrane to achieve the liquid backwash. The valve MV1 is adjusted to regulate the aeration flow and create a negative pressure differential between the feed and permeate sides of the module 5. It will be appreciated that, once the correct process conditions are decided, MV1 can be replaced by a fixed flow restricting device with no operator adjustment required.

In one form of this method, the manual valve MV1 is adjusted to reduce the air pressure to the shell side of the membrane module 5 within the vessel 6. Filtration is then suspended by closing valve AV1 and backwash release valve AV2 is opened. Low-pressure air is applied to the permeate remaining therein through non-return valve NRV3 and upper and lower module filtrate outlets 8 and 9. This low-pressure air forces the permeate liquid through the membrane pores from the permeate side to the feed side to produce a liquid backwash. This liquid backwash is performed for a period of 2 to 200 seconds, typically 45 seconds with a continuing aeration of the module 5 by application of blower air through MV1 and lower inlet port 10.

Once the liquid backwash is completed, the shell side of vessel 6 is swept with feed liquid to remove contaminants dislodged during the backwash and to further scour the outer surfaces of the membranes 7. This sweep may be optionally performed with continuing aeration for a period of 0 to 120 seconds, typically, about 10 seconds and then without aeration for a further period of 0 to 150 seconds, typically 30 seconds. It will be appreciated a drain down could be used in place of a sweep to remove dislodged contaminants. Once the backwash and sweep/drain down are completed, the system is returned to normal filtration.

A second preferred method uses a backwash pulse to increase the permeate side pressure and to backwash the membrane pores. In this method, during a backwash stage (including aeration and liquid backwash), the upper backwash valve AV2 is temporarily or partly closed to isolate the shell side of the vessel 6. The blower 11 is operated in dead-end mode or close to dead-end mode for a very short duration (air is largely released from blower's pressure release valve). Both the shell side and permeate side pressure builds up to the blower's discharge pressure limit. The shell side upper backwash valve AV2 is then opened, resulting in the shell side pressure dropping rapidly and a relatively high negative transmembrane pressure (TMP) pulse being generated. The pulse can be repeated by simply closing and opening upper backwash valve AV2 during the backwash stage. When this method is used, the filtrate non-return valve, NRV3, is desirably located as far as practical from the upper module permeate outlet 8 to provide efficient air pocket within the system to maximize the pressure pulse generated.

In one form of the preferred pulsed method of backwash the system is operated as follows.

Filtration is suspended and upper backwash valve AV2 is opened. An aeration and liquid backwash stage is then performed with low-pressure air for a period of 2 to 200 seconds, typically 10 seconds. As described in relation to the previous method, low pressure air is applied to permeate within the membrane lumens through permeate outlets 8 and 9 resulting in the permeate liquid being pushed through the membrane pores and dislodging contaminant material from the membrane walls. The shell side of the module 5 is then pressurized by closing upper backwash valve AV2 for a period of 1 to 60 seconds, typically 5 seconds and running the blower 11 in dead-end mode. The upper backwash valve AV2 is then opened to rapidly depressurise the vessel 6 while continuing aeration and liquid backwash with low-pressure air. This stage is typically performed for a period of 1-150 seconds.

Similar to the previous method, once the liquid backwash is completed, the shell side of vessel 6 is swept with feed liquid to remove contaminants dislodged during the backwash and to further scour the outer surfaces of the membranes 7. This sweep may be optionally performed with continuing aeration for a period of 0 to 120 seconds, typically about 10 seconds and then without aeration for a further period of 0 to 150 seconds, typically about 30 seconds. Once the backwash and sweep/drain down are completed the system is returned to normal filtration.

As described above, the pulse phase may be repeated by opening and closing the upper backwash valve AV2 a number of times, usually 1 to 4. Typically, during each pulse phase, the shell side of the vessel 6 is pressurized for 1-60 seconds followed by depressurisation phase with aeration and low-pressure liquid backwash for a period of 1-150 seconds.

A number of experiments have been performed to illustrate the effectiveness of the low-pressure backwash.

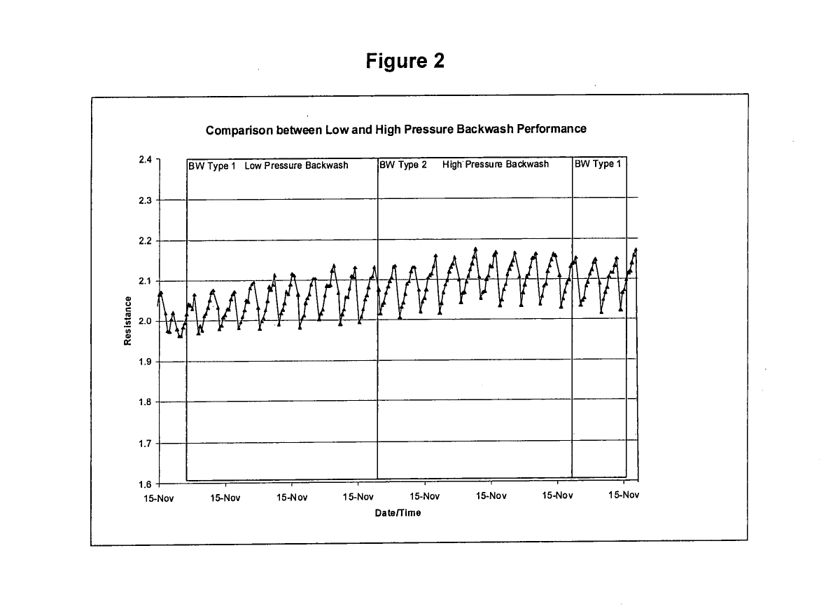

FIG. 2 shows a graphical comparison between a 30 kPa lumen pressure backwash and a typical 200 kPa lumen pressure backwash.

In another test, a comparison of the pulsed liquid backwash method with a normal low-pressure backwash was performed. Ten pulsed backwash operations were performed followed by ten normal low-pressure backwash operations. A backwash pressure pulse was generally around 3-10 seconds.

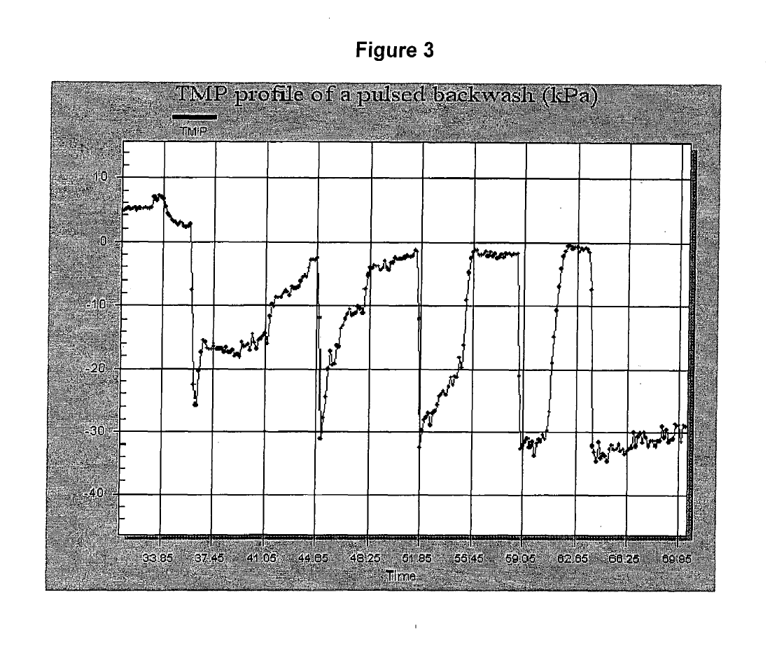

FIG. 3 shows a backwash snapshot of a multiple pulsed backwash.

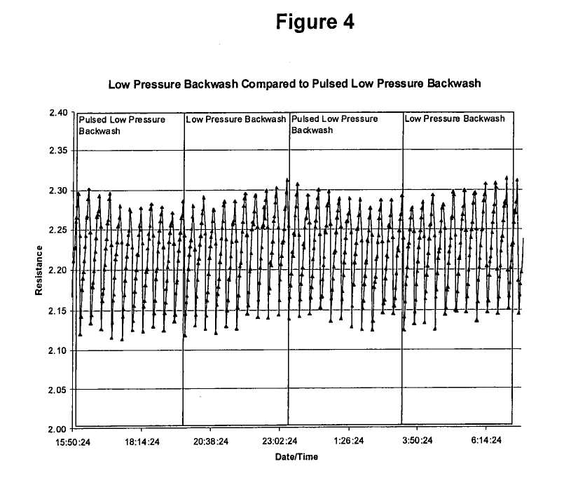

FIG. 4 shows the comparison of multiple pulsed low-pressure backwash operation with a normal low-pressure backwash operation. It can be clearly seen from these figures that the backwash performance of multiple pulsed backwashes is better than a low-pressure backwash operation without pressure pulses.

It will be appreciated that further embodiments and exemplifications of the invention are possible without departing from the spirit or scope of the invention described.

1. A method of backwashing a membrane filtration system comprising at least one permeable hollow membrane, the method comprising the step of applying a low-pressure gas to the permeate remaining present in the filtration system when the filtration process is stopped or suspended to provide liquid for backwashing pores of the membrane during a backwashing process, wherein the low-pressure gas is at a pressure in the range of about 30 kPa to about 150 kPa.

2. A method according claim 1 wherein the low-pressure gas is at a pressure below the bubble point of the membrane.

3. (canceled)

4. A method according to claim 1 wherein the low-pressure gas is provided by one or more gas pressure pulses.

5. A method of filtering solids from a liquid suspension comprising:
(i) providing a pressure differential across the walls of permeable, hollow membranes immersed in the liquid suspension, said liquid suspension being applied to the outer surface of the (porous) permeable hollow membranes to induce and sustain filtration through the membrane walls wherein:
(a) some of the liquid suspension passes through the walls of the membranes to be drawn off as permeate from the hollow membrane lumens, and
(b) at least some of the solids are retained on or in the hollow membranes or otherwise as suspended solids within the liquid surrounding the membranes,
(ii) periodically backwashing the membrane pores using the permeate remaining within the lumens by applying low pressure gas at a pressure below the bubble point of the membrane to said liquid permeate to displace at least some of the liquid permeate within the lumens through the membrane pores resulting in removal of the solids retained on or in the hollow membranes, wherein the low-pressure gas is at a pressure in the range of about 30 kPa to about 150 kPa.

6. A method of filtering solids from a liquid suspension in a filtration system comprising:
(i) providing a pressure differential across the walls of permeable, hollow membranes having a liquid suspension applied to the inner surface of the permeable hollow membranes to induce and sustain filtration through the membrane walls wherein:
(a) some of the liquid suspension passes through the walls of the membranes to be drawn off as permeate from the outer surface of said membranes, and
(b) at least some of the solids are retained on or in the hollow membranes or otherwise as suspended solids within the membranes,
(ii) stopping or suspending the filtration process;
(iii) periodically backwashing the membrane pores using the permeate remaining in the system after the suspension of the filtration process by applying a low pressure gas at a pressure below the bubble point of the membrane to said liquid permeate to displace at least some of the liquid permeate through the membrane pores resulting in removal of the solids retained on or in the hollow membranes wherein the low-pressure gas is at a pressure in the range of about 30 kPa to about 150 kPa.

7. A method according to claim 5 wherein, during the backwashing step, the solids are removed into the bulk liquid surrounding the membranes.

8. A method according to claim 5 wherein permeate remaining in ancillaries is used as a source of backwash liquid.

9. A method according to claim 5 further comprising providing a further chamber or reservoir in a permeate flow circuit to increase the amount of permeate available for backwashing.

10. A method according to claim 5 wherein the permeate is withdrawn from both ends of the membrane lumens and wherein the low pressure gas is applied to one or both ends of the membrane lumens during the backwashing step.

11. A method according to claim 5 wherein the low-pressure gas is provided by one or more gas pressure pulses.

12. A method according to claim 11 wherein the pressure pulse or pulses are provided by isolating the liquid suspension side of the membranes during the backwashing step while applying low pressure gas to both the liquid suspension side and the permeate side of the membranes to pressurize the liquid suspension and permeate sides of the membranes, then opening the liquid suspension side of the membranes to atmosphere resulting in a depressurisation of the liquid suspension side and the application of a pulse of pressure to the permeate side of the membranes.

13. A filtration system for removing fine solids from a liquid suspension comprising:
(i) a vessel for containing said liquid suspension;
(ii) a plurality of permeable, hollow membranes within the vessel;
(iii) means for providing a pressure differential across walls of said membranes such that some of the liquid suspension passes through the walls of the membranes to be drawn off as permeate;
(iv) means for withdrawing permeate from the membranes; and
(v) means for applying low pressure gas at a pressure below the bubble point to the liquid permeate within the system and the membrane lumens to cause a discharge of at least some of the liquid permeate in the lumens through the membrane walls to dislodge any solids retained therein and displace the removed solids into the liquid suspension surrounding the membranes, wherein the low-pressure gas is at a pressure in the range of about 30 kPa to about 150 kPa.

14. A filtration system according to claim 13 wherein the low-pressure gas is provided by one or more gas pressure pulses.

15. A filtration system according to claim 13 wherein the low-pressure gas is provided from a source of gas used to aerate the membranes.

16. A filtration system according to claim 13 wherein the gas pressure is regulated by a control valve or pressure-limiting device.

17. A filtration system according to claim 13 wherein the low-pressure gas is employed to push the remaining permeate through pores of the membrane wall.

18-19. (canceled)

20. A filtration system according to claim 13 wherein the low pressure is provided from a blower used for gas scouring of the membrane.

21. A filtration system according to claim 13 further comprising a number of the membrane modules, each membrane module comprising one or more of the membranes, wherein the membrane modules are arranged in a bank and connected to a manifold for distributing liquid suspension to the membrane modules and removing permeate therefrom, and wherein the low pressure gas is introduced into the manifold of the bank of membrane modules so that the permeate in the manifold forms part of the permeate within the system.

22. A method of backwashing a membrane filtration system comprising at least one permeable hollow membrane, the method comprising the step of applying a low-pressure gas to the permeate remaining present in the filtration system when the filtration process is stopped or suspended to provide liquid for backwashing pores of the membrane during a backwashing process, wherein the low-pressure gas is provided by one or more gas pressure pulses.

23. A method of filtering solids from a liquid suspension comprising:
(i) providing a pressure differential across the walls of permeable, hollow membranes immersed in the liquid suspension, said liquid suspension being applied to the outer surface of the permeable hollow membranes to induce and sustain filtration through the membrane walls wherein:
(a) some of the liquid suspension passes through the walls of the membranes to be drawn off as permeate from the hollow membrane lumens, and
(b) at least some of the solids are retained on or in the hollow membranes or otherwise as suspended solids within the liquid surrounding the membranes,
(ii) periodically backwashing the membrane pores using the permeate remaining within the lumens by applying low pressure gas at a pressure below the bubble point of the membrane to said liquid permeate to displace at least some of the liquid permeate within the lumens through the membrane pores resulting in removal of the solids retained on or in the hollow membranes, wherein the low-pressure gas is provided by one or more gas pressure pulses.

24. A method of filtering solids from a liquid suspension in a filtration system comprising:
(i) providing a pressure differential across the walls of permeable, hollow membranes having a liquid suspension applied to the inner surface of the permeable hollow membranes to induce and sustain filtration through the membrane walls wherein:
(a) some of the liquid suspension passes through the walls of the membranes to be drawn off as permeate from the outer surface of said membranes, and
(b) at least some of the solids are retained on or in the hollow membranes or otherwise as suspended solids within the membranes,
(ii) stopping or suspending the filtration process;
(iii) periodically backwashing the membrane pores using the permeate remaining in the system after the suspension of the filtration process by applying a low pressure gas at a pressure below the bubble point of the membrane to said liquid permeate to displace at least some of the liquid permeate through the membrane pores resulting in removal of the solids retained on or in the hollow membranes, wherein the low-pressure gas is provided by one or more gas pressure pulses.

25. A filtration system for removing fine solids from a liquid suspension comprising:
(i) a vessel for containing said liquid suspension;
(ii) a plurality of permeable, hollow membranes within the vessel;
(iii) means for providing a pressure differential across walls of said membranes such that some of the liquid suspension passes through the walls of the membranes to be drawn off as permeate;
(iv) means for withdrawing permeate from the membranes; and
(v) means for applying low pressure gas at a pressure below the bubble point to the liquid permeate within the system and the membrane lumens to cause a discharge of at least some of the liquid permeate in the lumens through the membrane walls to dislodge any solids retained therein and displace the removed solids into the liquid suspension surrounding the membranes, wherein the low-pressure gas is provided by one or more gas pressure pulses.
